(19) United States
(12) Patent Application Publication
(10) Pub. No.: US 2005/0050230 A1
(43) Pub. Date: Mar. 3, 2005

(54) Configurable ports on an electronic device

(76) Inventor: Hahn Vo, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/650,652

(22) Filed: Aug. 28, 2003

(51) Int. Cl. G06F 3/00

(52) U.S. Cl. 710/1

(57) ABSTRACT

Apparatus and methods that are directed to an electronic device that may include control logic and a plurality of ports configurable by the control logic as determined by a programmable register to operate as a single communication link to a single device or as a plurality of independent communication links to a plurality of devices.

### BACKGROUND

A variety of electronic devices may have one or more ports through which communications to other devices may be provided. Without limitation, a network switch is one such device. Typically, switches have ports by which the switch can be coupled to one or more switches, computers, routers, storage devices, and/or other network attached devices. Naturally, the number of devices to which a switch may be coupled is generally limited by the number of ports on the switch. For example, an eight-port switch typically may be coupled to eight or fewer other devices. Increased flexibility as to the number of devices that may be coupled to a multi-port electronic device is desirable.

### SUMMARY

In at least some embodiments, an electronic device comprises control logic and a plurality of ports. Each port is configurable by the control logic as determined by a programmable register to operate as a single communication link to a single device or as a plurality of independent communication links to a plurality of devices.

### BRIEF DESCRIPTION OF THE DRAWINGS

For a detailed description of embodiments of the invention, reference will now be made to the accompanying drawings in which:

FIG. 1 shows a system diagram including a programmable switch with a variable number of ports in accordance with various embodiments of the invention.

### NOTATION AND NOMENCLATURE

Certain terms are used throughout the following description. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

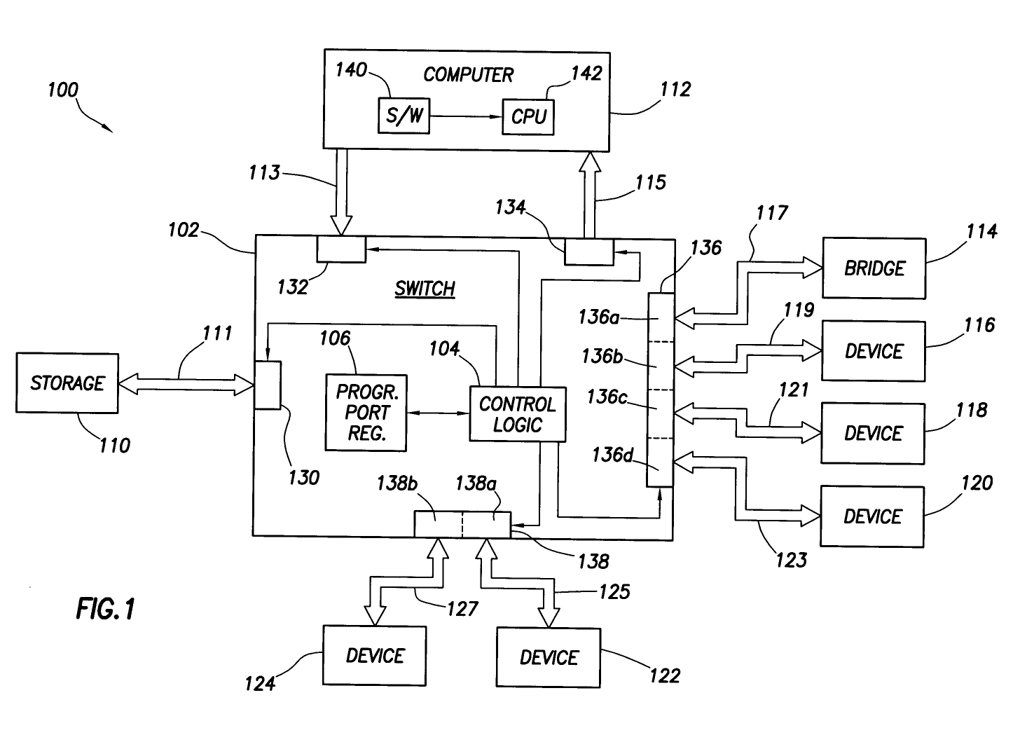

Referring now to FIG. 1, a system 100 is shown in accordance with various embodiments of the invention. As shown, system 100 may include an electronic device 102 coupled to one or more other electronic devices 110, 112, 114, 116, 118, 120, 122, and 124. Without limitation, device 102 may comprise a multi-port switch. Devices 110-124 may comprise any relevant type of electronic device such as a computer 112 (e.g., a server), a bridge 114, and a storage device 110 (e.g., volatile or non-volatile storage). In general, devices 102 and 110-124 may be other types of devices as well. For purposes of the following disclosure, device 102 may be referred to as a “switch,” but such reference shall not limit the scope of device 102 and certainly shall not limit the scope of the claims.

As a switch, device 102 may be used to route packets between devices 110-124 and may be useful to implement a computer network possibly having other such switches. Each device 110-124 may couple via a communication link to a port associated with the switch 102. The communication link comprises a plurality of conductors. The ports are shown in FIG. 1 as ports 130-136. Device 110 couples to switch 102 via communication link 111 to port 130. Device 112 may have two communication links 113 and 115 to switch ports 132 and 134. Devices 114-120 couple to switch 102 via links 117-123 to port 136, while device 122 and 124 couple to switch 102 via links 125, 127 to port 138.

Each port 130-138 may comprise a plurality of bus signals including, for example, address signals, data signals and control signals. Although any of a variety of bus standards may be implemented to interconnect the ports 130-128 with their respective external devices 110-124, in accordance with at least some embodiments, the PCI-X standard may be used. In accordance with the PCI-X standard, each PCI-X communication link may be implemented as a 64 bit link, 32 bit link, or 16 bit link. In general, however, the bit width of the communication links can be varied and is not a limitation on this disclosure including the claims unless otherwise specified.

At least one of the ports associated with the switch 102 and, in general, a plurality or all of the ports, may be configurable to be coupled to one or more devices, such as devices 110-124. For example, as shown in FIG. 1 port 130 is configured to couple to a single device 110. Ports 132 and 134 are each configured to couple to a single device 112 as well, albeit the same device. Ports 136 and 138, however, may be configured to couple to a plurality of devices. Port 136 may be configured to couple to four devices 114-120, while port 138 may be configured to couple to two devices 122, 124.

Referring still to FIG. 1, port 136 is configured into four “sub-ports” 136a-136d, each sub-port able to be coupled to a separate device and function as an independent port. The term “sub-port” is used simply to distinguish it from a port of which the sub-port is a part. As such, sub-ports may also be referred to as ports and generally sub-ports function similarly or identically to ports. Sub-port 136a couples via link 117 to device 114. Similarly, sub-port 136b, c and d couple via links 119, 121 and 123 to device 116, 118 and 120, respectively. Port 138 also is divided into multiple independently operable sub-ports. Sub-port 138 may couple via communication link 125 to device 122, while sub-port 138b may couple via link 127 to device 124. Thus, each port may be configured as a single port to a single device or as a plurality of sub-ports to a plurality of devices. As a plurality of sub-ports, each sub-port may be connected to a separate device or two or more sub-ports may be connected to the same device.

In accordance with at least some embodiments of the invention, the switch 102 also may include control logic 104 which may access programmable port registers 106. The control logic 104 may be implemented as a processor coupled to memory and executing code stored in the memory. Registers 106 are generally provided in the configuration space associated with the switch 102 and may or may not physically reside in the switch 102. The coordinated action of the control logic 104 and registers 106 permits each port 130-138 to be configured as a single port or multiple independent sub-ports. As such, the switch 102 effectively may have a variable and configurable number of ports thereby permitting the switch to be readily scaled as necessary. Configuring the switch's ports may occur during the initialization process for the switch 102 or dynamically during run-time as the switch's ports operate to route packets between devices as, for example, it becomes desirable to couple additional devices to the switch.

The communication links may be negotiated to an appropriate bus width (i.e., number of bits) that may be a maximum width permitted by the communication link or a width less than the maximum. In the case in which the link is negotiated to a width that is less than the maximum, one or more of the link's conductors may be unused. In accordance with various embodiments of the present invention, those conductors that would have been unused may be used to implement a separate communication link (i.e., sub-port). For example, if PCI-X is used to implement the various ports 130-138, each port may be implemented as either a single 64-bit link, one or two 32-bit links, one 32-bit link with one or two 16-bit links, or one to four 16-bit links. In general, each of a port's sub-ports (if sub-ports are programmed for the port) provides a communication link to a device that uses at least some of the same conductors that would be used if the port was configured to provide a single communication link to a single device (e.g., link 111 to device 110). As such, pins associated with the links need not be unused if a link requires fewer than the maximum number of bits available for the port—the excess conductors may be used for another link.

The registers 106 may be programmed to reflect how each of the ports 130-138 are to be configured. The registers 106 may include one or more registers for each of the ports 130-138 or a single register for all ports 130-138. Each register may include a plurality of bits (e.g., two) that encodes the configuration for the associated ports. These bits may be encoded as shown in the example of Table I below.

TABLE I

| Port configuration | |
|---|---|
| bits | Description |
| 00 | Port configured as one 64-bit link |
| 01 | Port configured as one 32-bit link and two 16-bit links |
| 10 | Port configured as two 32-bit links |
| 11 | Port configured as four 16-bit links |

One or more additional bits of port configuration may be included if additional configurations are desired, such as configurations in which a port is configured as two 16-bit ports or three 16-bit ports.

As explained above, a PCI-X interface may be configured to be (1) one 64-bit interface, (2) one 32-bit interface and one or two 16-bit interfaces, or (3) two, three or four 16-bit interfaces, although other configurations are possible as well, such as a single 16-bit interface or a single 32-bit interface. Table II below illustrates exemplary embodiments of how the signals may be used in conjunction with the various interface sizes. The example of Table II assumes that a port can be configured as, at most, a 64-bit interface, and no larger, although in other embodiments, larger size ports can be implemented.

TABLE II

| Signals | 64-bit | 32-bit | 16-bit |
|---|---|---|---|
| Control | 12 | 12 | 11 |
| AD | 64 | 32 | 16 |
| C/BE | 8 | 4 | 2 |
| ECC | 8 | 7 | 4 |
| SERR | 1 | 1 | 1 |
| Total | 93 | 56 | 34 |

As shown in Table II, a single 64-bit interface may comprise 93 signals with 12 signals used as control signals, 64 signals used as address/data (“AD”) signals, eight signals used as command/byte enable (“C/BE”) signals, eight signals as error correction code (“ECC”) signals and one signal as a system error (“SERR”) signal. If the port is programmed to provide one or two 32-bit interfaces, each 32-bit interface comprises 56 signals as listed above in the “32-bit” column. If the port is programmed to implement one or more 16-bit interfaces, each such interface comprises 34 signals as shown in the “16-bit” column. For example, if a port is configured as one 32-bit interface and two 16-bit interfaces, the 32 bit interface has the number of signals listed above in the “32-bit” column, while each of the 16-bit interfaces has the number of signals listed above in the “16-bit” column.

Each of the ports shown in FIG. 1 may be configured to have the needed number of signals of each type (control, AD, and so on) depending on how that port is programmed. Thus, port 130 may be programmed as a single 64-bit interface and, per Table II, have 12 control signals. Port 136, however, may be programmed as four 16-bit interfaces each comprising 11 control bits for a total of 44 control bits.

As noted above, the programmable port registers 106 may be used to configure the switch's ports 130-138 during initialization or dynamically during run-time. Software 140 running on a central processing unit (“CPU”) in computer 112, for example, may be used to program the registers 106. Such software generally may be aware of the number of devices to be coupled to switch 102 as well as the needed width of communication links to the devices. Such information may be determined or otherwise known as default values or from jumpers on a printed circuit in the switch 102. Further, the switch 102 may include a driver and associated graphical user interface (“GUI”). Via the GUI, a user may input such information into the configuration space allocated to the switch 102.

The software 140 may program the registers 106. Once programmed, the switch's control logic 104 may configure the various ports 130-138 using the information contained in the registers 106. This configuration process may occur during whatever initialization process may be performed in the switch 102. Alternatively, the control logic 104 may periodically poll the contents of registers 106 to determine if the programmed configuration has changed. If the control logic 104 determines that the contents of the registers 106 have changed, the control logic 104 may reconfigure the one or more of the ports 130-138 as specified by the registers. Further still, the software 140 that programs the contents of the registers 106 may cause the control logic 104 to be interrupted. The control logic 104 then may run an interrupt service routine which determines the source of the interrupt, reads the contents of the registers 106, and reconfigures one or more of the ports 130-138 as specified by the registers.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. An electronic device, comprising:
control logic; and
a plurality of ports configurable by said control logic as determined by a programmable register, wherein each of said ports is configurable to operate as a single communication link to a single device or as a plurality of independent communication links to a plurality of devices.

2. The device of claim 1 wherein said programmable register can be written to specify a configuration for each port.

3. The device of claim 2 wherein each port may have a configuration that differs from at least one other port.

4. The device of claim 2 wherein each port is configurable to one of a plurality of configurations by a plurality of bits associated with that port.

5. The device of claim 4 wherein said plurality of configurations includes a single communication link configuration and a multi-communication link configuration.

6. The device of claim 5 wherein said multi-communication link configuration includes a two communication link configuration and a four communication link configuration.

7. The device of claim 6 wherein said multi-communication link configuration further includes a three communication link configuration.

8. The device of claim 1 wherein each port is configurable to operate as a single communication link, a pair of independent communication links or four independent communication links.

9. The device of claim 1 wherein said device comprises a network switch that is adapted to receive port configuration information from a computer coupled to said switch.

10. A multi-port switch, comprising:
a processor; and
a plurality of ports configurable by said processor, each port adapted to couple to a device to form at least part of a network, and wherein each of said ports is configurable to operate as either a single communication link to a single device or as a plurality of sub-ports to a plurality of separate devices.

11. The switch of claim 10 wherein one of said devices transmits configuration information to said switch, said configuration specifying how each port is to be configured.

12. The switch of claim 10 wherein the ports can be configured dynamically while the switch is operating to route packets between devices coupled to said switch.

13. The switch of claim 10 wherein each port is configurable to operate as at least three sub-ports.

14. A switch, comprising:
control logic;
a plurality of ports coupled to said control logic;
means for selectively configuring each of said ports to operate as a single communication link to a single device or as a plurality of communication links each to a separate device.

15. The switch of claim 14 wherein said means includes means for selectively configuring each port to operate as two or four communication links.

16. The switch of claim 14 wherein said means includes means for configuring each port differently than at least one other port.

17. A switch, comprising:
a plurality of ports adapted to couple to a plurality of network devices, each port providing at least one communication link; and
control logic operable to configure the switch to dynamically vary the number of communication links associated with at least one port.

18. The switch of claim 17 wherein three or more links are configured with the at least one port.

19. The switch of claim 17 wherein a port comprises a single communication link and the at least one port comprises at least two independently operable communication links.

20. The switch of claim 19 wherein the at least one port comprises at least three independently operable communication links.

21. The switch of claim 17 wherein each port is programmable to have a different number of communication links than at least one other port.

22. The switch of claim 17 wherein each port is programmable to have a communication link having a width that is different from a width that is programmable in at least one other communication link.

23. A network, comprising:
a multi-port switch; and
a plurality of network devices coupled to said switch and in communication with each other via said switch;
wherein each port can be programmed to provide a plurality of independently operable links to at least some of said network devices, each port also being programmable to provide a single communication link to only a single network device.

24. The network of claim 23 wherein one of said network devices provides programming information to said switch to program said ports.

25. The network of claim 23 wherein each port can be programmed to provide one, two, three or four independent communication links.

26. The network of claim 25 wherein the port includes a plurality of conductors and wherein said two, three and four communication links are formed using at least some of the same conductors that are used when the port provides only a single communication link.

27. A method, comprising:
determining the number of devices coupled to a switch port; and
programming said switch port to provide two or more independent communication links if said number is greater than one.

28. The method of claim 27 wherein the switch port includes conductors and wherein programming the switch port includes causing said two or more independent communication links to be formed using at least some of the conductors that are used if only a single device couples to said switch port.
